(19) United States
(12) Patent Application Publication
(10) Pub. No.: US 2015/0256566 A1
(43) Pub. Date: Sep. 10, 2015

(54) Project Collaboration

(71) Applicant: Call-It-Out, Inc., Santa Monica, CA (US)

(72) Inventor: Alexander David Grappo, Silverthorne, CO (US)

(73) Assignee: Call-It-Out, Inc., Santa Monica, CA (US)

(21) Appl. No.: 14/199,832

(22) Filed: Mar. 6, 2014

(51) Int. Cl. H04L 29/06; G06F 17/30

(52) U.S. Cl. CPC H04L 65/403; G06F 17/30864; G06F 17/30106; G06F 17/30041

(57) ABSTRACT

Methods, systems, and apparatus, including computer programs encoded on computer storage media, for collaborating on projects. One of the methods includes receiving, at a user device, an indication of an update to a project, the project being identified by a project identifier. A camera device associated with the user device is activated in response to receiving the indication of the update to the project. Subject content is provided to a serving system, and the serving system provides a presentation thread of a project identified by the project identifier, the presentation thread comprising the subject content of the subject. The presentation thread of the project is presented on the user device.

### BACKGROUND

This specification relates to collaborative content systems.

User content systems, e.g., social networks, can receive user content, e.g., images, videos, microblog messages, and status updates and can make such information available to other users over a network, e.g., the Internet.

### SUMMARY

This specification describes how users can collaborate on a project by sharing subject content about the project using mobile user devices. A serving system can receive the subject content and generate a presentation thread for the project. A user device can then present the presentation thread, which can appear, for example, as a conversation of photo and video posts.

In general, one innovative aspect of the subject matter described in this specification can be embodied in methods that include the actions of receiving, at a user device, an indication of an update to a project, the project being identified by a project identifier; activating a camera device associated with the user device in response to receiving the indication of the update to the project; receiving, at the user device, subject content of a subject; associating the subject content with the project identifier; providing the subject content to a serving system; and receiving, from the serving system, a presentation thread of a project identified by the project identifier, the presentation thread comprising the subject content of the subject; and presenting, by the user device, the presentation thread of the project. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. The actions include determining a project identifier from one or more items of project metadata. Determining a project identifier from one or more items of project metadata comprises providing the project metadata to the serving system; receiving, from the serving system, a project identifier matching the project metadata and project information for a project identified by the project identifier; presenting the project information; and receiving a user selection of the project information. Providing the project metadata to the serving system comprises obtaining a location of the user device; and providing the location of the user device to the serving system. Providing the project metadata to the serving system comprises obtaining a user identifier of the user; and providing the user identifier to the serving system. Providing the project metadata to the serving system comprises obtaining a job identifier of a job associated with the project; and providing the job identifier to the serving system. Providing the project metadata to the serving system comprises obtaining a building identifier or a room identifier associated with the project; and providing the building identifier or a room identifier to the serving system. The presentation thread comprises a sequence of updates provided by collaborators for the project.

Particular embodiments of the subject matter described in this specification can be implemented so as to realize one or more of the following advantages. Multiple users can easily track and share updates about a subject in an intuitive conversation of photos and videos about the subject that is updated in real-time. This can allow the users to efficiently address issues in a wide variety of real-world contexts, e.g., building maintenance or construction site issues.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-D illustrate example user interfaces of an example application for project collaboration.

FIG. 2 illustrates an example system.

FIG. 3 is a flow chart of an example process for collaborating on a project.

Like reference numbers and designations in the various drawings indicate like elements.

### DETAILED DESCRIPTION

In this specification, a project refers to a collaborative collection of content provided by one or more users addressing a same particular subject. In general, the users collaborate by sharing subject content, e.g., photos, videos, audio, or other electronic documents including word processing documents, spreadsheet documents, presentation documents, or Portable Document Format (PDF) documents, about the subject or subject content that refers to the subject. The users may also be referred to as collaborators. The project can include subject content provided by users on real-world subjects, e.g., photos of building maintenance issues. A project can be said to be about a subject when it includes subject content about the subject.

Projects can have associated metadata that describes the project, which users can use to distinguish one project from another. Project metadata can include any appropriate identifying or descriptive information for a particular project. For example, project metadata can include a GPS location of a subject, a user identifier of a collaborator of the project, a site, job, building, or room identifier where the subject is located.

Projects can be owned by an administrator, who can assign a group of one or more collaborators to a project. Each collaborator can then post updates for projects to which the collaborator has been assigned. For example, the collaborators assigned to a project can be team members in an organization. In some implementations, a user who creates a project is the administrator of the project by default. The project administrator may allow updates to be added by any user or additional collaborators to be added by other collaborators or by any user.

Users can use mobile devices to collaborate on projects in a variety of scenarios. For example, users that are construction workers can use mobile devices to track the progress of a building or other job site. Maintenance workers can use mobile devices to track issues in a building and share updates with management.

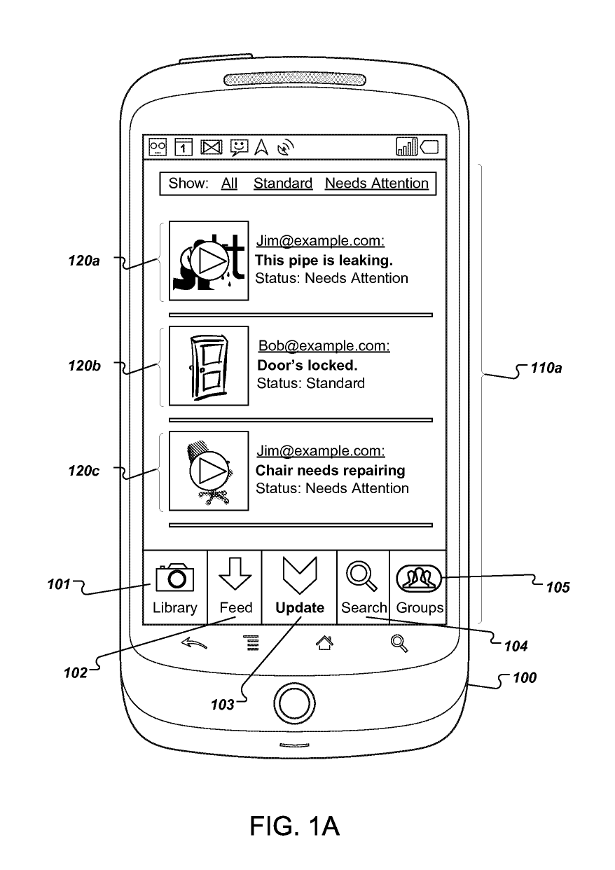

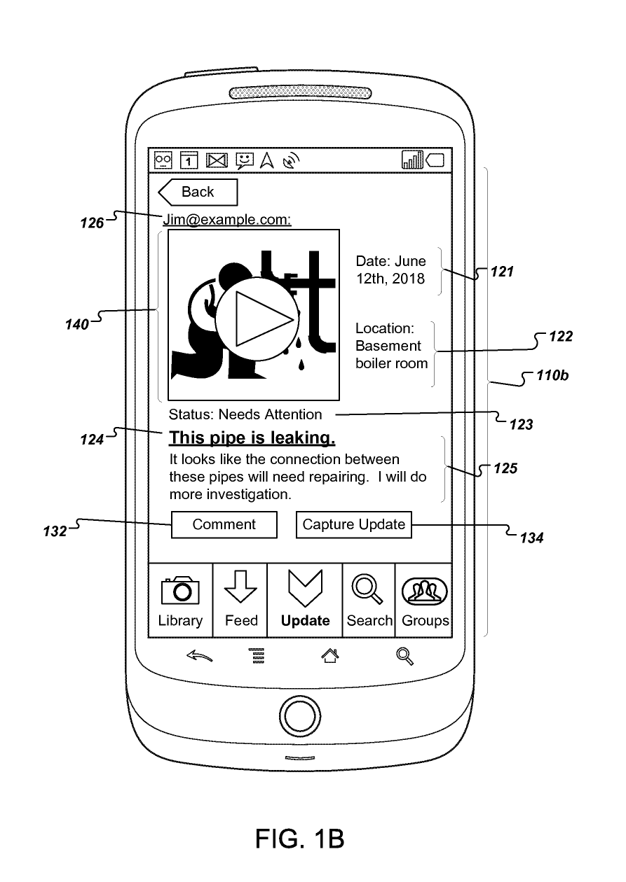

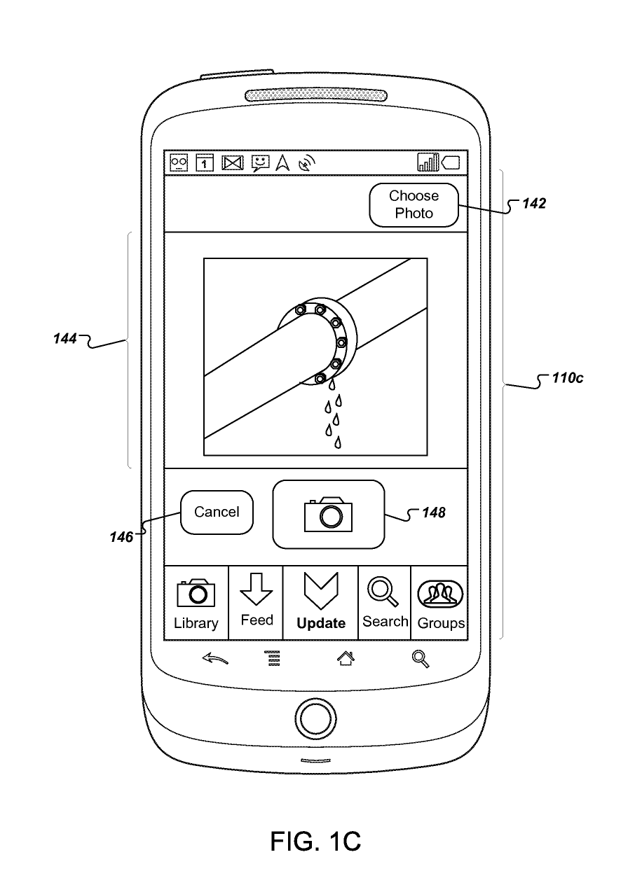

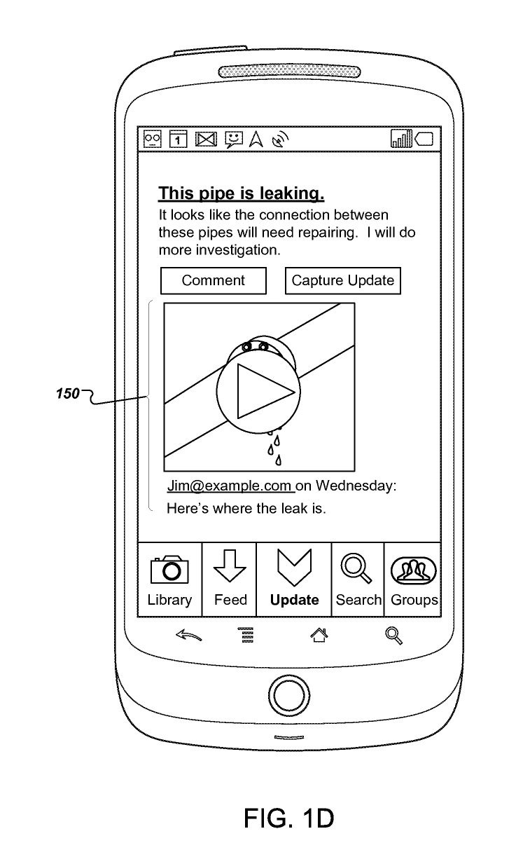

FIG. 1A illustrates an example user interface 110a showing project search results for multiple projects. The example interface 110a can be provided as functionality of a user application installed on a mobile user device 100, e.g., a smartphone or a tablet computer. A user can use the user interface 110a to find and manage projects, e.g., projects on which the user is a collaborator.

The user interface 110a presents a first project search result 120a for a project about a leaky pipe. A second project search result 120b includes information for a project about a door, and a third project search result 120c includes information for a project about a chair that needs fixing. A user can select, e.g., by touching a touch sensitive surface, one of the rows 120a-c to view a presentation thread about the corresponding project, which is described in more detail below with reference to FIG. 1B. The project search results 120a-c shown in the user interface 110a can be provided by a serving system that maintains project information and associated subject content.

A user can search for projects by providing any appropriate metadata associated with the project. The user application can identify matching projects that are stored locally on the user device 100, or the user application can provide a request to the serving system. For example, the serving system can receive project queries from user devices and respond by providing project search results for projects that match the project queries. The user application can present project search results received from the serving system in any appropriate format, e.g., as a list as illustrated in FIG. 1A.

A user can search for projects by location. For example, the user can provide the user application with a particular location, which the user device 100 can forward to the serving system. The serving system can then obtain matching projects that are associated with a location that is within a threshold distance of the location of the user device. In some implementations, the user application by default uses a current location of the user device 100, e.g., as determined by global positioning system (GPS) functionality of the user device 100. The user can also specify a location that represents a particular site, a building, or a room of a particular building.

The user application may populate and update project search results in the user interface 110a automatically. For example, the user application can automatically provide a user identifier of a user to the serving system. The serving system can then identify matching projects to which the user is a collaborator or an administrator and provide project search results for the matching projects to the user device 100. In some implementations, the user application automatically provides a user identifier to the serving system and populates the user interface 110a with matching projects at the time that the user application is launched.

The user application can also automatically populate the user interface 110a by searching for nearby projects. A nearby project can be defined as a project that is associated with a location that is within a threshold distance of a location of the user device 100. For example, the user application can provide a current location of the user device 100 to the serving system. The serving system can then provide project search results for matching projects that are associated with locations that are within a threshold distance to the location of the user device. The user application may then rank the projects according to distance to the location of the user device 100, for example.

A user can also indicate, to the serving system, that he or she is a collaborator on projects associated with a particular location. For example, a particular user can be assigned to handle maintenance tasks in a particular building. The user application used by the particular user can then automatically request project search results for projects associated with the particular building, e.g., by providing a project query that specifics the building identifier.

The user application generally includes a number of menu options 102-105. Upon selection of the library menu option 101, the user application presents subject content that the user has captured. Upon selection of the feed menu option 102, the user application will communicate with the serving system to obtain a list of projects for which the user is a collaborator. Upon selection of the update menu option 103, the user application will provide the user with an interface for capturing subject content. Upon selection of the search menu option 104, the user application will provide the user with an interface for searching for projects. Upon selection of the groups menu option 105, the user application will present a list of collaboration groups to which the user belongs.

FIG. 1B illustrates an example user interface 110c showing a presentation thread for a project. A presentation thread is a sequence of updates provided by collaborators for a particular project. Each update in a presentation thread can include a date 121, a location 122, a status 123, a title 124, a description 125, and a user identifier 126 of a collaborator that provided the update. Each update can also include subject content, e.g., the subject video 140. Some updates lack subject content. For example, a user can provide an update that includes comment about a subject without capturing a photo or video of the subject.

A user can add an update to a particular project by selecting the Comment button 132 or the Capture Update button 134. User selection of the Comment button 132 will allow the user to provide an update that includes only a comment on the project.

User selection of the Capture Update button 134 can activate an integrated camera device of the user device 102 for capturing an image or video of a subject. Using the capture update button 134 allows a user to quickly provide updates on a project in a streamlined and efficient manner.

FIG. 1C illustrates an example user interface 110c for capturing subject content. A user can use viewfinder 144 to locate the subject and preview a captured image or video of the subject. When a user selects the camera interface control 148, the user application directs an integrated camera of the user device 100 to capture an image, audio, or video of the subject. The user can alternatively decline to capture the subject content by selecting “cancel” interface control 146.

The user interface 110c can also allow a user to choose preexisting subject content using image selection interface control 142. For example, the user can select a preexisting electronic file, e.g., an image or video stored locally on the user device 100. If selecting or capturing an image or a video, the user application can provide the user with options to apply various filters to the image or video data or other manipulation options. For example a user can choose to have an image of the subject, originally captured in color, to appear as a black-and-white image.

The user application can then generate an update using the subject content and associate the update with the project. The user can use the application to associate other metadata with the update, for example, a description or title of the update or a location of the subject. In addition, the user application may also include other dedicated user interfaces for associating metadata with the update. For example, the user application may include a user interface through which the user can assign a category or topic to the update. Topic or category information may be associated with the update as a “hashtag” or keyword that signals a topic or category occurring inline within text, e.g., within a title or a description of the update. In some implementations, the user application may automatically associate with the update geographic location information, e.g., GPS coordinates, that corresponds to where the user device 102 was located when the subject content was captured. The application can store the update locally on user device 102, or the application can communicate with a serving system to upload the update for serving to other collaborators on the project.

FIG. 1D illustrates an example update 150 to a presentation thread. After a user captures subject content for an update, the user application can add the update 150 to the presentation thread. The updates to the presentation thread can thus act as a conversation of electronic files, e.g., photos, audio, video, or other documents, about the subject of the project.

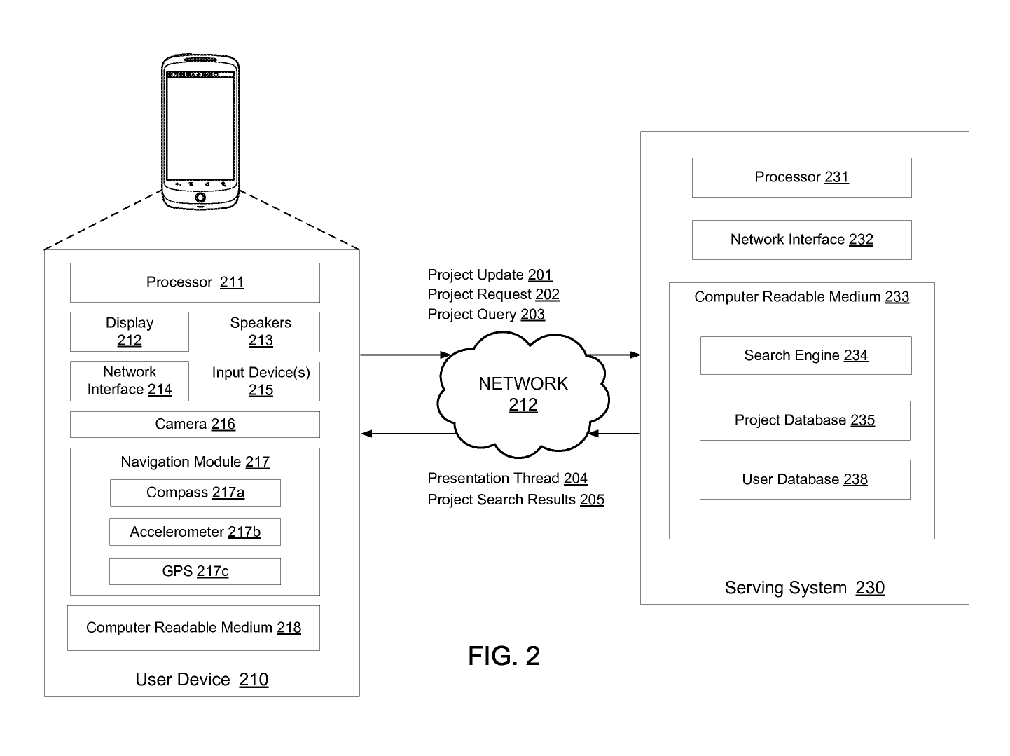

FIG. 2 illustrates an example system 200. The example system includes a user device 210, a network 220, and a serving system 230. The user device 210 can communicate over network 220 to provide a project update 201, a project request 202, or a project query 203 to the serving system 230.

The serving system 230 can receive the project update 201 and associate the project update 201 with a particular project in a project database 235. The serving system 230 can receive a project request 202 and respond with a presentation thread 204 for the particular project. The serving system 230 can respond to a project query 203 by providing a project search results 205. A user device 110 may be a smart wristwatch, a mobile phone, a portable music player, a tablet computer, a laptop computer, a PDA (Personal Digital Assistant), a smartphone, or another handheld or wearable mobile device.

The user device 210 can include one or more processors 211, a display 212, one or more speakers 213, one or more input devices 215, a network interface 214, a camera 216, a navigation module 217, and a non-volatile computer-readable medium 218. In other implementations, the user device 210 is not portable or mobile, but rather is a desktop or laptop computer or a server. In still other implementations, some of these structural elements are omitted or combined.

The display 212 may display video, graphics, images, and text that make up the user interface for the software applications used by the user device 210, and for the operating system programs used to operate the user device 210. Among the possible elements that may be displayed on the display 212 are various indicators, e.g., new mail, active phone call, data transmit/send, signal strength, battery life, and application icons, e.g., web browser, phone application, search application, contacts application, mapping application, email application. In one example implementation, the display 212 is a quarter video graphics array (QVGA) thin film transistor (TFT) liquid crystal display (LCD), capable of 16-bit or better color.

The one or more speakers 213 allow the user device 210 to convert an electrical signal into sound, such as a voice signal from another user generated by a telephone application program, or a ring tone signal generated from a ring tone application program.

The camera 216 allows the user device 210 to capture digital images, and may be a scanner, a digital still camera, a digital video camera, or other digital input device. In one example implementation, the camera 216a is a 12 megapixel (MP) or more camera.

The navigation module 217 includes a compass 271a, an accelerometer 217b, and a GPS (Global Positioning Satellite) receiver 217c. The GPS receiver 217c receives GPS signals in order to determine a current location. The compass 217a determines a direction pointed to by the orientation of user device 210. The accelerometer 217b may, for example, measure tilt, motion, or acceleration of the user device 210. The navigation module 217 may include other functionality, such as the ability to determine the location of the mobile device 210 using triangulation techniques based on WiFi signals and/or cellular tower signals.

The processor 211 processes operating system or application program computer instructions for the user device 210. The input devices 215 may include, for example, a wireless keyboard. A keyboard may be used for entering text data and user commands into the user device 210.

The network 220 can include, for example, one or more of the Internet, a wireless local area network (WLAN) or WiFi network, a Third Generation (3G), Fourth Generation (4G), or other mobile telecommunications network, a wired Ethernet network, a private network such as an intranet, Wide Area Networks (WANs), Local Area Networks (LANs), analog or digital wired and wireless telephone networks, e.g., a PSTN, Integrated Services Digital Network (ISDN), and Digital Subscriber Line (xDSL), radio, television, cable, satellite, and/or any other delivery or tunneling mechanism for carrying data services, or any appropriate combination thereof. Networks may include multiple networks or subnetworks, each of which may include, for example, a wired or wireless data pathway.

The serving system 230 may be connected to the network 220 and possibly to one or more other networks over the network interface 232. Similarly, the user device 210 may be connected to the network 220 and possibly to one or more other networks over the network interface 214 of the user device 210.

The processor 231 processes operating system or application program computer instructions for the serving system 230, and may be part of one or more computers in one or more locations that are coupled to each other through a network, e.g., network 220.

The computer-readable medium 233 stores and records information or data, and may be an optical storage medium, magnetic storage medium, flash memory, or any other storage medium type. The medium 233 includes a search engine 234, a subject content database 235, a maps database 236, and a user database 238. The search engine 234 obtains project search results 205 for matching projects that the search engine 234 identifies as being responsive to a project query 204.

The project database 235 stores updates that are associated with projects, including subject content and other associated metadata for the updates, e.g., location information, descriptions, titles, and collaborators. The search engine 234 can search project database 235 to identify project search results 205 that are responsive to a received project query 203.

The user database 238 stores information about collaborators in the serving system. For example, the user database 238 can store associations between user identifiers and projects on which the users are collaborators.

While FIG. 2 illustrates an example system for serving subject content as described by this specification, other systems are possible. For instance, one or more of the functionalities described in association with the serving system 230, above, may actually be performed by the user device 210, and vice versa. Furthermore, one or more modules, databases, and applications shown as being stored in medium 233 may actually be stored in the medium 218, and vice versa. Similarly, a user interface may be generated and displayed at the user device 210 using information received from the serving system 230. Alternatively, the user interface may be generated at the serving system 230, where the serving system 230 transmits code, e.g., an HTML document, that, when rendered by the user device 210, causes the user device 210 to display the user interface.

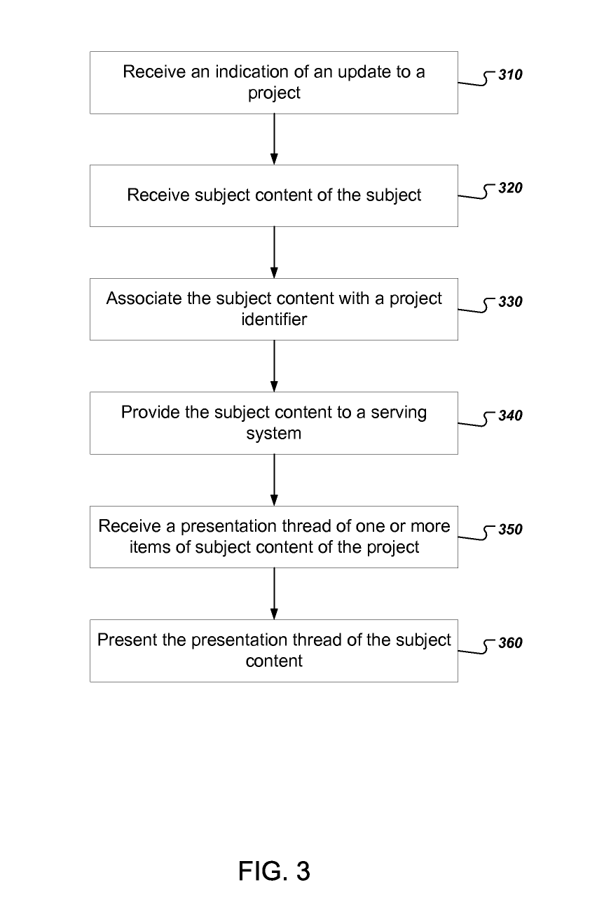

FIG. 3 is a flow chart of an example process for collaborating on a project. In general, a user device captures subject content for a particular project and provides the subject content to a serving system. The serving system then updates a presentation thread for the project and the user device presents the presentation thread to a user. The process can be implemented by one or more computer programs installed on one or more computers. The process will be described as being performed by an appropriately programmed user device, e.g., the user device 100 of FIG. 1A.

The user device receives an indication of an update to a project (310). As described above with reference to FIG. 1A, a user can make a selection on the user device to indicate that an update to the project is available.

In some implementations, the user can search for and select a particular project to which the update should be applied. For example, the user can perform a search as described above with reference to FIG. 1A, using any appropriate project metadata including a location, a user identifier, a job identifier, a building, a room, or a site.

The user may also be provided a default list of projects that are assigned to the user or to the user's supervisor, or associated with a location, building or site where the user works.

The user device receives subject content of the subject (320). The user can capture or select subject content to associate with the project. For example, the user device can activate a camera integrated with the user device. In some implementations, the camera is activated directly after receiving the indication of the update and without requiring further input from the user.

The user device can also receive the subject content from user selection of a preexisting electronic file, e.g., an image, video, or other electronic file that is stored on or accessible from the user device, for example, as described above with reference to FIG. 1C.

The user device associates the subject content with a project identifier (330). For example, the user device can maintain a subject content database that is local to the user device and which maintains associations between captured subject content and project identifiers.

The user device can also receive and associate additional metadata with the subject content. For example, in some implementations, the user device automatically obtains a geographic location of the user device at the time the subject content was captured and automatically associates the geographic location with the subject content. A user can manually associate other metadata with the subject content, for example, a category, title, description, date, in addition to other types of metadata.

The user device provides the subject content to a serving system (340). The serving system can identify a project using the project identifier and update project information using the received subject content. The system can then generate a presentation thread for the project using the updated subject content.

The user device receives a presentation thread of one or more items of subject content of the project (350). The presentation thread can include the recently provided subject content for the project. In some implementations, the serving system provides subject content for a particular project to the user device and the user device generates the presentation thread.

The user device presents the presentation thread of the subject content (360). For example, the subject content can be presented in a presentation thread as shown above with reference to FIG. 1D.

The serving system can then provide updates to the project presentation thread to user devices of other users. The other users can view the updates, add comments, or update the project with additional subject content.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, at a user device, an indication of an update to a project, the project being identified by a project identifier;
activating a camera device associated with the user device in response to receiving the indication of the update to the project;
receiving, at the user device, subject content of a subject;
associating the subject content with the project identifier;
providing the subject content to a serving system; and
receiving, from the serving system, a presentation thread of a project identified by the project identifier, the presentation thread comprising the subject content of the subject; and
presenting, by the user device, the presentation thread of the project.

2. The method of claim 1, further comprising determining a project identifier from one or more items of project metadata.

3. The method of claim 2, wherein determining a project identifier from one or more items of project metadata comprises:
providing the project metadata to the serving system;
receiving, from the serving system, a project identifier matching the project metadata and project information for a project identified by the project identifier;
presenting the project information; and
receiving a user selection of the project information.

4. The method of claim 3, wherein providing the project metadata to the serving system comprises:
obtaining a location of the user device; and
providing the location of the user device to the serving system.

5. The method of claim 3, wherein providing the project metadata to the serving system comprises:
obtaining a user identifier of the user; and
providing the user identifier to the serving system.

6. The method of claim 3, wherein providing the project metadata to the serving system comprises:
obtaining a job identifier of a job associated with the project; and
providing the job identifier to the serving system.

7. The method of claim 3, wherein providing the project metadata to the serving system comprises:
obtaining a building identifier or a room identifier associated with the project; and
providing the building identifier or a room identifier to the serving system.

8. The method of claim 1, wherein the presentation thread comprises a sequence of updates provided by collaborators for the project.

9. A system comprising:
one or more computers and one or more storage devices storing instructions that are operable, when executed by the one or more computers, to cause the one or more computers to perform operations comprising:
receiving, at a user device, an indication of an update to a project, the project being identified by a project identifier;
activating a camera device associated with the user device in response to receiving the indication of the update to the project;
receiving, at the user device, subject content of a subject;
associating the subject content with the project identifier;
providing the subject content to a serving system; and
receiving, from the serving system, a presentation thread of a project identified by the project identifier, the presentation thread comprising the subject content of the subject; and
presenting, by the user device, the presentation thread of the project.

10. The system of claim 9, wherein the operations further comprise determining a project identifier from one or more items of project metadata.

11. The system of claim 10, wherein determining a project identifier from one or more items of project metadata comprises:
providing the project metadata to the serving system;
receiving, from the serving system, a project identifier matching the project metadata and project information for a project identified by the project identifier;
presenting the project information; and
receiving a user selection of the project information.

12. The system of claim 11, wherein providing the project metadata to the serving system comprises:
obtaining a location of the user device; and
providing the location of the user device to the serving system.

13. The system of claim 11, wherein providing the project metadata to the serving system comprises:
obtaining a user identifier of the user; and
providing the user identifier to the serving system.

14. The system of claim 11, wherein providing the project metadata to the serving system comprises:
obtaining a job identifier of a job associated with the project; and
providing the job identifier to the serving system.

15. The system of claim 11, wherein providing the project metadata to the serving system comprises:
obtaining a building identifier or a room identifier associated with the project; and
providing the building identifier or a room identifier to the serving system.

16. The system of claim 9, wherein the presentation thread comprises a sequence of updates provided by collaborators for the project.

17. A computer program product, encoded on one or more non-transitory computer storage media, comprising instructions that when executed by one or more computers cause the one or more computers to perform operations comprising:
receiving, at a user device, an indication of an update to a project, the project being identified by a project identifier;
activating a camera device associated with the user device in response to receiving the indication of the update to the project;
receiving, at the user device, subject content of a subject;
associating the subject content with the project identifier;
providing the subject content to a serving system; and
receiving, from the serving system, a presentation thread of a project identified by the project identifier, the presentation thread comprising the subject content of the subject; and
presenting, by the user device, the presentation thread of the project.

18. The computer program product of claim 17, wherein the operations further comprise determining a project identifier from one or more items of project metadata.

19. The computer program product of claim 18, wherein determining a project identifier from one or more items of project metadata comprises:
providing the project metadata to the serving system;
receiving, from the serving system, a project identifier matching the project metadata and project information for a project identified by the project identifier;
presenting the project information; and
receiving a user selection of the project information.

20. The computer program product of claim 19, wherein providing the project metadata to the serving system comprises:
obtaining a location of the user device; and
providing the location of the user device to the serving system.
